(19) United States
(12) Patent Application Publication
(10) Pub. No.: US 2012/0069957 A1
(43) Pub. Date: Mar. 22, 2012

(54) RADIOLOGICAL IMAGE DISPLAYING DEVICE AND METHOD

(75) Inventor: Hiroki NAKAYAMA, Ashigarakami-gun (JP)

(73) Assignee: FUJIFILM CORPORATION, Tokyo (JP)

(21) Appl. No.: 13/232,608

(22) Filed: Sep. 14, 2011

(30) Foreign Application Priority Data
Sep. 17, 2010 (JP) 2010-208756

(51) Int. Cl. H05G 1/61

(52) U.S. Cl. 378/21

(57) ABSTRACT

Diagnosis using a tomographic image and a stereoscopic image can be easily performed. A reconstruction unit generates a tomographic image from a plurality of radiological images with different radiographing directions, which is stored in a radiological image storage unit. A display control unit displays a stereoscopic image using a standard radiological image and a reference radiological image, among the plurality of radiological images, on a monitor. In this case, the tomographic image is superimposed on the stereoscopic image.

### BACKGROUND OF THE INVENTION

1. Field of the Invention

The present invention relates to a radiological image displaying device and method for displaying a stereoscopic image of a subject.

2. Description of the Related Art

In recent years, in order to observe the affected part in more detail with a radiological image radiographing apparatus, tomosynthesis radiographing has been proposed in which a radiation source is moved to irradiate a subject from a plurality of different directions and images acquired by such radiographing are added to obtain an image which emphasizes a desired cross section (refer to JP2008-110098A). In the tomosynthesis radiographing, a plurality of radiological images is acquired by radiographing a subject at a plurality of irradiation positions of different irradiation angles by moving a radiation source in parallel to a radiation detector or moving the radiation source so as to draw the arc of a circle or ellipse according to the characteristics or a required tomographic image of a radiographing apparatus, and these radiological images are reconstructed using a back projection method such as a simple back projection method or a filtered back projection method, for example, to generate a tomographic image.

Moreover, as disclosed in JP2008-264519A, a mammography radiographing apparatus used for breast screening and the like is known as one of the radiological image radiographing apparatuses. Many of the mammography radiographing apparatuses are basically configured to include a radiation plane in which a radiation detector is built and which supports a breast that is a radiographing part of a subject, a compression plate which is disposed opposite the radiation plane and compresses the breast against the radiation plane, and a radiation source which emits radiation to the breast through the compression plate.

On the other hand, an apparatus which displays a stereoscopic image (a three-dimensional image or a stereo image) based on stereoscopic image data including the information regarding parallax between both left and right eyes has also been proposed as an apparatus which displays a medical image, such as a radiological image. Such an apparatus irradiates a subject from different directions, detects radiation transmitted through the subject using a radiation detector to acquire a plurality of radiological images with parallax, and displays a stereoscopic image based on these radiological images in a three-dimensional manner. Thus, since a radiological image can be observed with a sense of depth by displaying a stereoscopic image in a three-dimensional manner, diagnosis can be more easily performed.

In addition, a method has also been proposed in which when acquiring a tomographic image by disposing a radiation source and a radiation detector opposite each other with a subject located therebetween, rotating the radiation source and the radiation detector around the subject, emitting radiation from various angles to capture a plurality of radiological images, and performing CT radiographing to display an arbitrary cross section by reconstructing a tomographic image using the radiological image from each of the angles, not only is the tomographic image displayed but also a stereoscopic image is displayed using two of the plurality of radiological images captured from the adjacent irradiation angles (refer to JP2009-183742A). Using this method, two radiological images for displaying a tomographic image and a stereoscopic image can be acquired by one radiographing.

### SUMMARY OF THE INVENTION

In the method disclosed in JP2009-183742A, however, the tomographic image and the stereoscopic image are displayed on separate display devices. For this reason, when making a diagnosis using both the images, the amount of movement of the observer's viewpoint is increased. As a result, it becomes difficult to make a diagnosis using both the images.

The present invention has been made in view of the above-mentioned problems and an object of the present invention is to provide to make a diagnosis using a tomographic image and a stereoscopic image easy.

According to an aspect of the present invention, there is provided a radiological image displaying device including: image acquisition part for acquiring two radiological images for displaying a stereoscopic image of a subject and a tomographic image of the subject; and display control part for displaying the stereoscopic image on display part using the two radiological images, the display control part displaying the tomographic image on the display part so as to be superimposed on the stereoscopic image.

In addition, in the radiological image displaying device according to the aspect of the present invention, the image acquisition part may include tomographic image generating part for generating a tomographic image of a desired cross section of the subject by reconstructing a plurality of radiological images including the two radiological images obtained by radiographing the subject from a plurality of different radiographing directions.

In this case, the tomographic image generating part may be a part for generating a tomographic image of a cross section corresponding to a stereoscopic effect of the stereoscopic image.

In this case, the tomographic image generating part may be a part for generating a tomographic image of a cross section corresponding to a display surface when displaying the stereoscopic image on the display part.

In addition, in the radiological image displaying device according to the aspect of the present invention, the display control part may be a part for displaying the stereoscopic image so as to obtain a stereoscopic effect with the tomographic image as a reference.

In this case, the display control part may be a part for displaying the stereoscopic image so that a surface corresponding to the cross section of the tomographic image is stereoscopically viewed on a display surface of the display part.

According to another aspect of the present invention, there is provided a radiological image displaying method including: acquiring two radiological images for displaying a stereoscopic image of a subject and a tomographic image of the subject; and when displaying the stereoscopic image on display part using the two radiological images, displaying the tomographic image on the display part so as to be superimposed on the stereoscopic image.

According to the aspect of the present invention, since the tomographic image is displayed so as to be superimposed on the stereoscopic image when displaying the stereoscopic image using the two radiological images, the stereoscopic image and the tomographic image can be observed on the same screen. Therefore, since there is no need to move the viewpoint greatly when making a diagnosis using both the images, the burden on the observer can be reduced. As a result, diagnosis using both the images can be easily performed.

Moreover, by generating the tomographic image of the cross section corresponding to the stereoscopic effect of the stereoscopic image or displaying the stereoscopic image so as to obtain a stereoscopic effect with the tomographic image as a reference, both the images can be easily viewed when the stereoscopic image and the tomographic image are superimposed.

In particular, when displaying a stereoscopic image on the display part, the position of the cross section of a tomographic image in the stereoscopic image can be easily recognized by generating a tomographic image of the cross section corresponding to a display surface of the display part or displaying the stereoscopic image such that a surface corresponding to the cross section of the tomographic image is stereoscopically viewed on the display surface of the display part. As a result, diagnosis can be more easily performed.

### BRIEF DESCRIPTION OF THE DRAWINGS

FIG. 1 is a view showing the schematic configuration of a radiological image radiographing apparatus to which a radiological image displaying device according to an embodiment of the present invention is applied.

FIG. 2 is a view when an arm unit of the radiological image radiographing apparatus shown in FIG. 1 is seen from the right side of FIG. 1.

FIG. 3 is a block diagram showing the schematic configuration inside a computer of the radiological image radiographing apparatus shown in FIG. 1.

FIG. 4 is a view showing a plurality of radiographing directions.

FIG. 5 is a view showing a reconstruction range of a tomographic image.

FIG. 6 is a view for explaining superposition of a tomographic image.

FIG. 7 is a view for explaining a stereoscopic effect of a breast in a stereoscopic image.

FIG. 8 is a flow chart showing the processing performed in the present embodiment.

### DESCRIPTION OF THE PREFERRED EMBODIMENTS

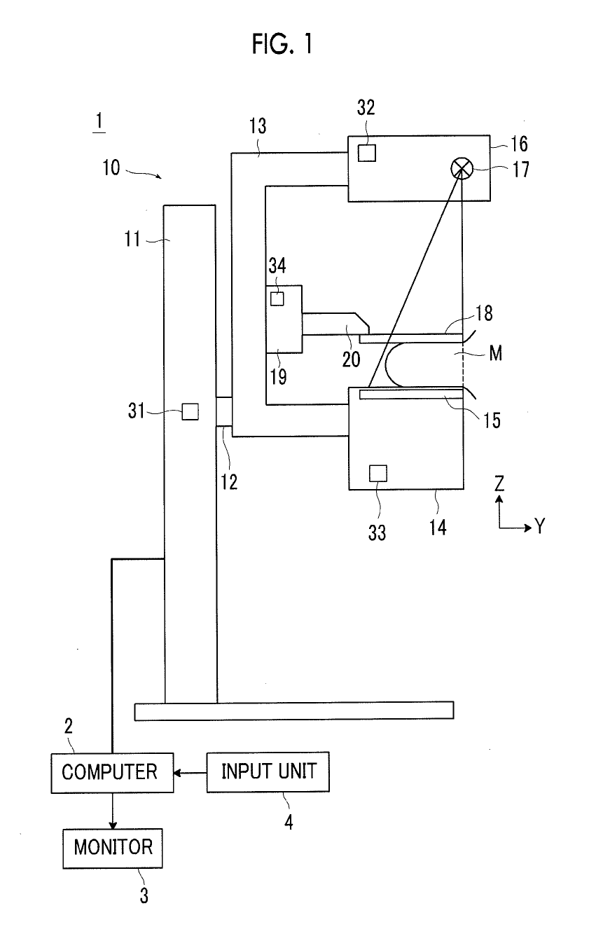

Hereinafter, embodiments of the present invention will be described with reference to the accompanying drawings. FIG. 1 is a view showing the schematic configuration of a radiological image radiographing apparatus to which a radiological image displaying device according to an embodiment of the present invention is applied. A radiological image radiographing apparatus 1 acquires a plurality of radiological images by generating a tomographic image by performing tomosynthesis radiographing of a breast M and also by radiographing the breast M from different radiographing directions in order to generate a stereoscopic image for stereoscopic viewing of a radiological image of the breast M. As shown in FIG. 1, the radiological image radiographing apparatus 1 includes a radiographing unit 10, a computer 2 connected to the radiographing unit 10, and a monitor 3 and an input unit 4 connected to the computer 2.

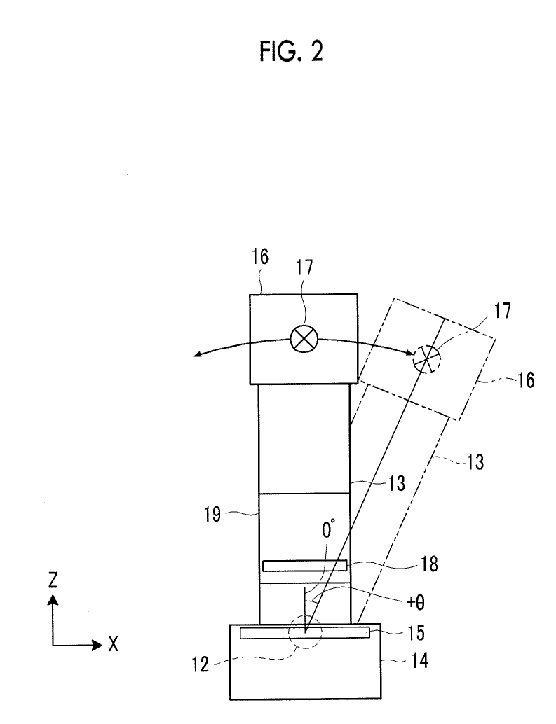

The radiographing unit 10 includes a pedestal 11, a rotary shaft 12 which can rotate and move up and down (in a Z direction) with respect to the pedestal 11, and an arm unit 13 connected to the pedestal 11 by the rotary shaft 12. In addition, FIG. 2 shows the arm unit 13 when viewed from the right side in FIG. 1.

The arm unit 13 has a shape of a letter C. A radiation plane 14 is fixed to one end of the arm unit 13, and an irradiating unit 16 is fixed to the other end so as to face the radiation plane 14. Rotation and up-and-down movement of the arm unit 13 are controlled by an arm controller 31 provided in the pedestal 11.

A radiation detector 15, such as a flat panel detector, and a detector controller 33 which controls reading of a charge signal from the radiation detector 15 are provided inside the radiation plane 14.

In addition, a circuit board on which a charge amplifier that converts a charge signal read from the radiation detector 15 into a voltage signal, a correlated double sampling circuit that samples a voltage signal output from the charge amplifier, an AD converter that converts a voltage signal into a digital signal, and the like are provided is placed inside the radiation plane 14.

In addition, the radiation plane 14 is configured to be able to rotate with respect to the arm unit 13. Accordingly, even when the arm unit 13 rotates with respect to the pedestal 11, the direction of the radiation plane 14 can be fixed with respect to the pedestal 11.

The radiation detector 15 can perform recording and reading of a radiological image repeatedly. A so-called direct-conversion type radiation detector which generates an electric charge by direct reception of radiation may be used, or a so-called indirect-conversion type radiation detector which converts radiation into visible light and then converts the visible light into a charge signal may be used. Moreover, as a method of reading a radiological image signal, a so-called TFT reading method in which a radiological image signal is read by ON/OFF of a TFT (thin film transistor) switch or a so-called optical reading method in which a radiological image signal is read by irradiation of reading light is preferably used. However, other methods may be used without being limited to the above methods.

A radiation source 17 and a radiation source controller 32 are provided in the irradiating unit 16. The radiation source controller 32 controls an irradiation timing of radiation from the radiation source 17 and the radiation generating conditions (tube current, time, tube current time product, and the like) in the radiation source 17.

In addition, a compression plate 18 provided above the radiation plane 14 to compress a breast, a supporting unit 20 which supports the compression plate 18, and a moving mechanism 19 which moves the supporting unit 20 up and down (in the Z direction) are provided in the middle of the arm unit 13. The position and the pressure of the compression plate 18 are controlled by a compression plate controller 34.

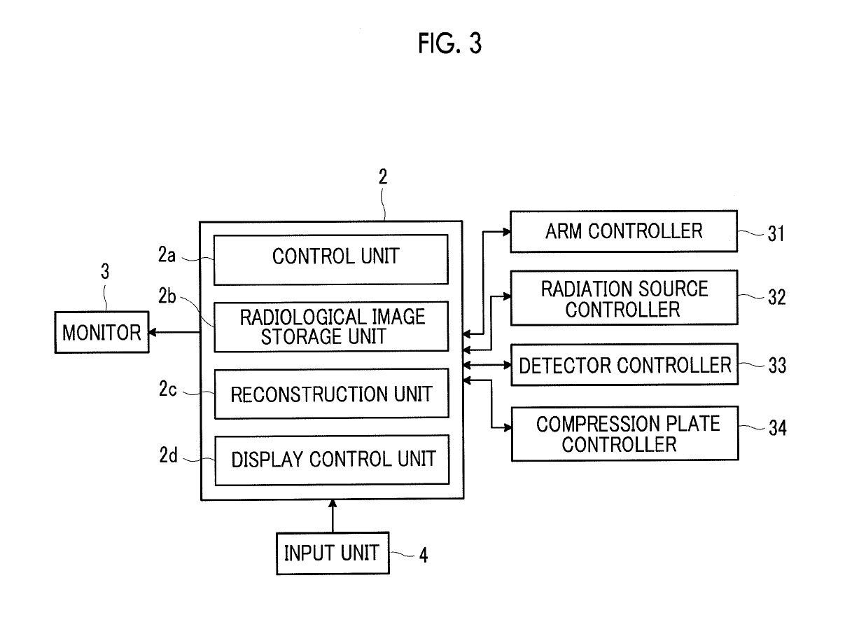

The computer 2 includes a central processing unit (CPU) and a storage device, such as a semiconductor memory, a hard disk, or an SSD. By such hardware, a control unit 2a, a radiological image storage unit 2b, a reconstruction unit 2c, and a display control unit 2d shown in FIG. 3 are formed.

The control unit 2a outputs predetermined control signals to various kinds of controllers 31 to 34 to control the entire apparatus.

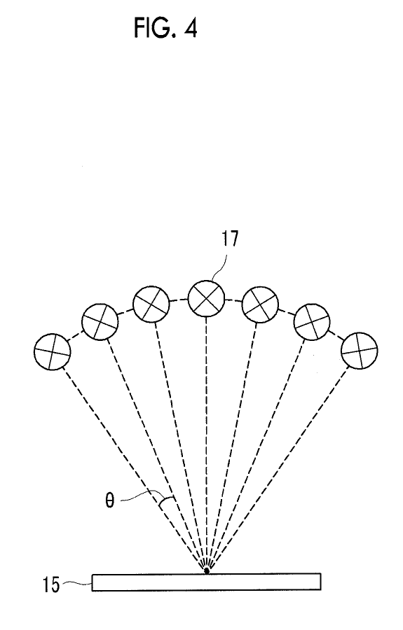

The radiological image storage unit 2b stores a plurality of radiological images that the radiation detector 15 detects by performing radiographing from a plurality of radiographing directions at predetermined angles θ shown in FIG. 4 while rotating the arm unit 13. Moreover, in the present embodiment, a tomographic image of the breast M generated from the plurality of radiological images is displayed. At the same time, a stereoscopic image using a radiological image (referred to as a standard radiological image G1) acquired by radiographing the breast from a direction of 0° (that is, a direction perpendicular to the radiation detector 15), among the plurality of radiological images, and a radiological image (referred to as a reference radiological image G2) whose radiographing direction is different by +θ° or −θ° from that of the standard radiological image G1 is displayed. In addition, regarding the rotation direction of the arm unit 13, right-handed rotation in FIG. 2 is a positive direction and left-handed rotation is a negative direction.

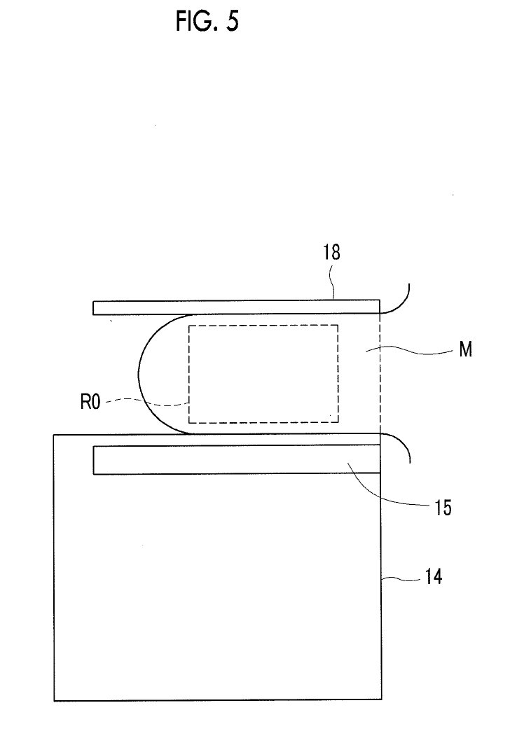

The reconstruction unit 2c generates a tomographic image which emphasizes a desired cross section of the breast M by reconstructing the plurality of radiological images stored in the radiological image storage unit 2b. Specifically, the reconstruction unit 2c generates a tomographic image by reconstructing these radiological images using a back projection method, such as a simple back projection method or a filtered back projection method. In addition, the reconstruction unit 2c generates a tomographic image of a desired cross section, which is parallel to the detection plane of the radiation detector 15, within a reconstruction range R0 set in advance in the breast M as shown in FIG. 5. Here, the desired cross section refers to a cross section including a part in which the observer is interested, such as a cross section required to observe an affected part in more detail.

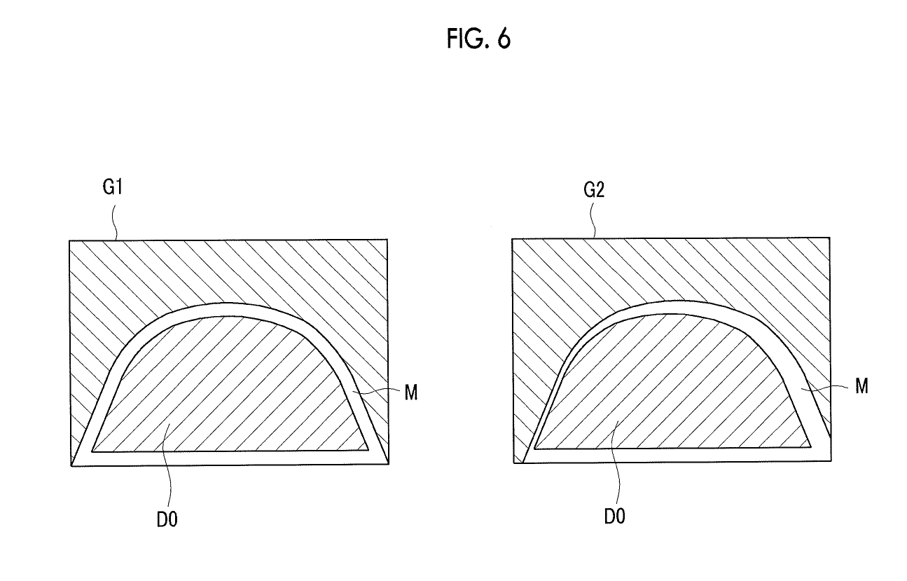

The display control unit 2d displays the tomographic image D0, which has been generated by the reconstruction unit 2c, on the monitor 3 so as to be superimposed on the stereoscopic image using the standard radiological image G1 and the reference radiological image G2. Specifically, as shown in FIG. 6, the display control unit 2d disposes the tomographic image D0 on each of the standard radiological image G1 and the reference radiological image G2 such that the parallax becomes 0. Accordingly, when displaying the stereoscopic image using the standard radiological image G1 and the reference radiological image G2, the parallax of the tomographic image D0 becomes 0. For this reason, the tomographic image D0 is stereoscopically viewed so that the stereoscopic effect corresponds to the display surface of the monitor 3. In addition, the display control unit 2d outputs the standard radiological image G1 and the reference radiological image G2, on which the tomographic image D0 is superimposed, to the monitor 3 according to the three-dimensional display method of the monitor 3. In addition, the display control unit 2d may adjust a stereoscopic effect of a stereoscopic image by adjusting parallax of the standard radiological image G1 and the reference radiological image G2.

The monitor 3 is configured to be able to perform three-dimensional display of a stereoscopic image using the standard radiological image G1 and the reference radiological image G2 on which the tomographic image D0 is superimposed and which are output from the computer 2. As an example of the three-dimensional display method of the monitor 3, a method may be adopted in which the standard radiological image G1 and the reference radiological image G2 are displayed using two screens and one of the radiological images is incident on the right eye of an observer and the other radiological image is incident on the left eye of the observer using a half mirror, a polarization glass, and the like to thereby display a stereoscopic image. In addition, a method of displaying a stereoscopic image by superimposing the standard radiological image G1 and the reference radiological image G2 and making these radiological images observable with a polarization glass may also be used. In addition, the monitor 3 may be formed by a 3D display and a method by which stereoscopic viewing of the standard radiological image G1 and the reference radiological image G2 is possible, such as a parallax barrier method and a lenticular method, may be used.

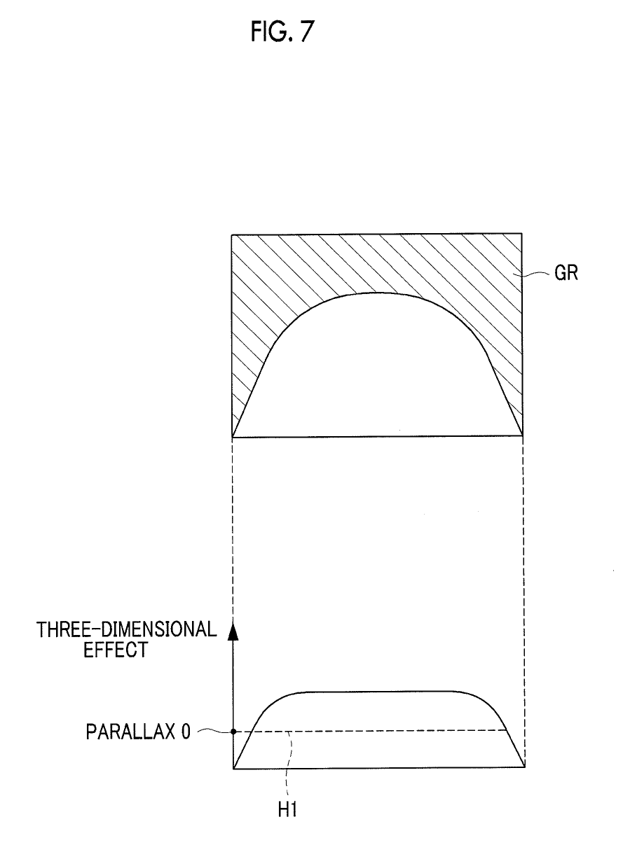

Here, the reconstruction unit 2c generates the tomographic image D0 of the cross section corresponding to the stereoscopic effect of the stereoscopic image. Specifically, when displaying a stereoscopic image on the monitor 3, an image of the breast M is stereoscopically viewed but a structure in which parallax is 0, among structures included in the standard radiological image G1 and the reference radiological image G2, is stereoscopically viewed so as to be located on the display surface of the monitor 3. FIG. 7 is a view for explaining the stereoscopic effect of the breast M in a stereoscopic image. As shown in FIG. 7, the stereoscopic effect of a stereoscopic image GR displayed on the monitor 3 approximately corresponds to the shape of the breast M compressed by the compression plate 18. In addition, although the stereoscopic effect of a structure differs depending on the parallax of structures included in the standard radiological image G1 and the reference radiological image G2 at the time of radiographing, a structure in which parallax is 0 is stereoscopically viewed so as to be located on the display surface of the monitor 3. For example, in FIG. 7, a structure with a stereoscopic effect indicated by a dotted line H1 which corresponds to parallax 0 is stereoscopically viewed so as to be located on the display surface of the monitor 3.

Thus, the reconstruction unit 2c specifies a position of a structure in which parallax of the standard radiological image G1 and the reference radiological image G2 is 0 and generates the tomographic image D0 of a cross section including the position. That is, generating the tomographic image D0 of the cross section corresponding to the stereoscopic effect of a stereoscopic image refers to generating the tomographic image D0 of the cross section corresponding to the dotted line H1, which is shown in FIG. 7, in the reconstruction range R0 of the breast M.

In addition, a stereoscopic image may be displayed by generating the tomographic image D0 of a desired cross section first by the reconstruction unit 2c and adjusting the parallax of the standard radiological image G1 and the reference radiological image G2 such that parallax of a structure included in the tomographic image D0 becomes 0 in the standard radiological image G1 and the reference radiological image G2. In other words, a stereoscopic image may be displayed in a three-dimensional manner by generating the tomographic image D0 of a desired cross section and adjusting the parallax of the standard radiological image G1 and the reference radiological image G2 such that parallax of a structure corresponding to a structure included in the tomographic image D0 becomes 0, that is, such that a stereoscopic effect with the tomographic image as a reference is obtained.

The input unit 4 includes a keyboard or a pointing device, such as a mouse, and receives from an operator an input of radiographing conditions, an input of a radiographing start instruction, and the like.

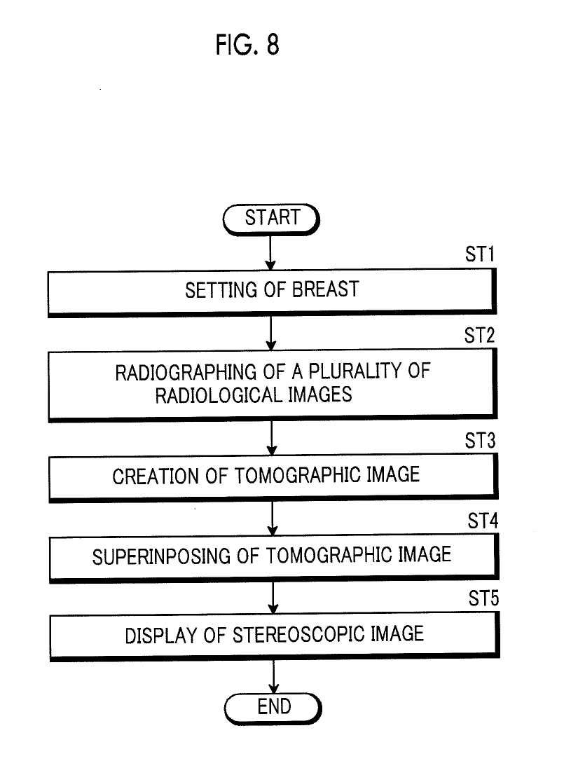

Next, processing performed in the present embodiment will be described. FIG. 8 is a flow chart showing the processing performed in the present embodiment. First, the breast M of a patient is placed on the radiation plane 14 and is compressed with predetermined pressure by the compression plate 18 (step ST1). Then, various radiographing conditions are input through the input unit 4 and then an instruction to start radiographing is input.

If there is an instruction to start radiographing through the input unit 4, radiographing of a plurality of radiological images is performed (step ST2). Specifically, first, the control unit 2a reads an angle θ which defines a radiographing distance set in advance and outputs the information of the read angle θ to the arm controller 31. In addition, in the present embodiment, θ=4° is stored in advance as the information of the angle θ at this time. However, an operator may set an arbitrary angle as the angle θ through the input unit 4 without being limited to θ=4°.

Then, the arm controller 31 receives the information of the angle θ output from the control unit 2a. According to this information, first, the arm controller 31 outputs a control signal to make the position of the arm unit 13 become an initial position most inclined with respect to the radiation plane 14.

Then, in a state where the arm unit 13 is at the initial position according to the control signal output from the arm controller 31, the control unit 2a outputs control signals to the radiation source controller 32 and the detector controller 33 in order to perform irradiation and reading of a radiological image signal. According to this control signal, radiation is emitted from the radiation source 17, a radiological image obtained by radiographing the breast M from the initial position is detected by the radiation detector 15, a radiological image signal is read from the radiation detector 15 by the detector controller 33, and predetermined signal processing is performed on the radiological image signal. Then, the result is stored as a radiological image in the radiological image storage unit 2b of the computer 2.

Then, the arm controller 31 outputs a control signal to make the arm unit 13 rotate by +θ° from the initial position. That is, in the present embodiment, the arm controller 31 outputs a control signal to make the arm unit 13 rotate by 4° from the initial position in a direction toward the end position at which the final radiographing is performed. Then, in a state where the arm unit 13 has rotated by 4° according to the control signal output from the arm controller 31, the control unit 2a outputs control signals to the radiation source controller 32 and the detector controller 33 in order to perform irradiation and reading of a radiological image signal.

Then, the controller 2a outputs control signals to the radiation source controller 32 and the detector controller 33 in order to perform irradiation and reading of a radiological image signal. According to this control signal, radiation is emitted from the radiation source 17, a radiological image obtained by radiographing the breast M from the position moved by 4° from the initial position is detected by the radiation detector 15, a radiological image signal is read by the detector controller 33, and predetermined signal processing is performed. Then, the result is stored as a radiological image in the radiological image storage unit 2b of the computer 2.

Then, a plurality of radiological images is stored in the radiological image storage unit 2b by repeating the above-described processing until the arm unit 13 rotates up to the end position.

Then, the reconstruction unit 2c extracts the standard radiological image G1 and the reference radiological image G2 among the plurality of radiological images and specifies a cross section including a structure, in which parallax in the standard radiological image G1 and the reference radiological image G2 becomes 0, in the reconstruction range of a tomographic image of the breast M. The reconstruction unit 2c generates the tomographic image D0 of the specified cross section by reconstructing the plurality of radiological images (step ST3). Then, the display control unit 2d superimposes the tomographic image D0 on each of the standard radiological image G1 and the reference radiological image G2 such that the parallax becomes 0 (step ST4), displays on the monitor 3 a stereoscopic image using the standard radiological image G1 and the reference radiological image G2 on which the tomographic image D0 is superimposed (step ST5), and ends the processing. On the stereoscopic image displayed on the monitor 3, the structure included in the breast M has a stereoscopic effect. Accordingly, a tomographic image of a cross section which further corresponds to the stereoscopic effect is displayed together.

Thus, in the present embodiment, since the tomographic image D0 is displayed so as to be superimposed on a stereoscopic image when displaying the stereoscopic image, the stereoscopic image and the tomographic image can be observed on the same screen. Accordingly, since there is no need to move the viewpoint greatly when making a diagnosis of the breast M using both a stereoscopic image and a tomographic image, the burden on the observer can be reduced. As a result, diagnosis of the breast M using both the images can be easily performed.

Especially on a radiological image of the breast M, calcification can be satisfactorily observed on a stereoscopic image and a tumor can be satisfactorily observed on a tomographic image. Therefore, by displaying the tomographic image D0 so as to be superimposed on the stereoscopic image, both the calcification and the tumor can be satisfactorily observed.

Moreover, when displaying a stereoscopic image on the monitor 3, the position of the cross section of a tomographic image in the stereoscopic image can be easily recognized by generating a tomographic image of the cross section corresponding to a display surface of the monitor 3 or displaying the stereoscopic image such that a surface corresponding to the cross section of the tomographic image is stereoscopically viewed on the display surface of the monitor 3. As a result, diagnosis can be more easily performed.

In addition, although a radiological image acquired by radiographing the breast M from a direction of 0° is used as the standard radiological image G1 in the embodiment described above, an image acquired by radiographing the breast M from a different direction from 0° may be used as a reference of two radiological images for displaying a stereoscopic image. In this case, a stereoscopic image is preferably displayed using a radiological image radiographed from the different direction from 0° as the standard radiological image G1.

In addition, in the embodiment described above, a tomographic image is generated by reconstructing a plurality of radiological images acquired by tomosynthesis radiographing. However, the tomographic image may also be generated by disposing a radiation source and a radiation detector opposite each other with a subject located therebetween, rotating the radiation source and the radiation detector around the subject, emitting radiation from various angles to capture a plurality of radiological images, and performing CT radiographing to display an arbitrary cross section by reconstructing a tomographic image using the radiological image from each of the angles.

In addition, in the embodiment described above, an ultrasonic tomographic image acquired by ultrasonic radiographing may also be used as a tomographic image.

In addition, although the radiological image radiographing apparatus to which the radiological image displaying device according to the above-described embodiment of the present invention is applied is used as an apparatus which radiographs a radiological image of a breast, a subject is not limited to the breast. For example, a radiological image radiographing apparatus which radiographs a chest, a head, and the like may also be used.

What is claimed is:

1. A radiological image displaying device comprising:
an image acquisition part for acquiring two radiological images for displaying a stereoscopic image of a subject and a tomographic image of the subject; and
a display control part for displaying the stereoscopic image on display part using the two radiological images, the display control part displaying the tomographic image on the display part so as to be superimposed on the stereoscopic image.

2. The radiological image displaying device according to claim 1,
wherein the image acquisition part includes tomographic image generating part for generating a tomographic image of a desired cross section of the subject by reconstructing a plurality of radiological images including the two radiological images obtained by radiographing the subject from a plurality of different radiographing directions.

3. The radiological image displaying device according to claim 2,
wherein the tomographic image generating part is a part for generating a tomographic image of a cross section corresponding to a stereoscopic effect of the stereoscopic image.

4. The radiological image displaying device according to claim 3,
wherein the tomographic image generating part is a part for generating a tomographic image of a cross section corresponding to a display surface when displaying the stereoscopic image on the display part.

5. The radiological image displaying device according to claim 2,
wherein the display control part is a part for displaying the stereoscopic image so as to obtain a stereoscopic effect with the tomographic image as a reference.

6. The radiological image displaying device according to claim 5,
wherein the display control part is a part for displaying the stereoscopic image so that a surface corresponding to the cross section of the tomographic image is stereoscopically viewed on a display surface of the display part.

7. A radiological image displaying method comprising:
acquiring two radiological images for displaying a stereoscopic image of a subject and a tomographic image of the subject; and
when displaying the stereoscopic image on display part using the two radiological images, displaying the tomographic image on the display part so as to be superimposed on the stereoscopic image.
